(19) United States
(12) Patent Application Publication
(10) Pub. No.: US 2006/0109273 A1
(43) Pub. Date: May 25, 2006

(54) Real-time multi-media information and communications system

(76) Inventors: Joaquin Shadow Rams, Manassas, VA (US); Lance Travis Miller, Alexandria, VA (US); Matthew Lee Keith, Dale City, VA (US)

Correspondence Address: NIXON & VANDERHYE, PC, 901 NORTH GLEBE ROAD, 11TH FLOOR, ARLINGTON, VA, 22203, US

(21) Appl. No.: 10/992,115

(22) Filed: Nov. 19, 2004

(51) Int. Cl. G06T 15/70

(52) U.S. Cl. 345/473

(57) ABSTRACT

An interactive multi-media information and communication system translates an intelligible data stream with discrete elements into one or more logically derived output data streams. The discrete data elements are analyzed by real-time dictionary look-up processing procedures to determine context, application and rule settings. The outcome of the analysis is used to determine if the input data element is to be discarded, or if one or more output elements are to be selected and presented in one or more output data streams.

### BACKGROUND OF THE INVENTION

1. Field of the Invention

An interactive multi-media information and communication system translates an intelligible data stream with discrete elements into one or more logically derived output data streams. The discrete data elements are analyzed by real-time dictionary look-up processing procedures to determine context, application and rule settings. The outcome of the analysis is used to determine if the input data element is to be discarded, or if one or more output elements are to be selected and presented in one or more output data streams.

2. Description of the Related Art

Various types of interactive information and communication systems have been disclosed in the prior art, as evidenced by the patents to Liles, et al., No. 5,880,731 and Sutton No. 6,539,354, and the pending Levine application Serial No. 6,539,354, and the pending Levine application Serial No. US 2001/0049596 A1.

In Levine, a text string is used to convey a text message that is analyzed to determine the concept being discussed. Visual images, which are related to the concept being conveyed by the text, can be added to enhance the reading of the text by providing an animated visual representation of the message.

This is a traditional static processing model where a block of data (a full sentence or statement) is captured, analyzed, processed, and then displayed. Each animation is a full run of the program that results in the production of a specific animation. While this process could be made to appear as an on-the-fly process, processing does not proceed until receipt of a “statement” is complete. If the criterion for statement completion is not received, processing waits and no story or output is generated. If the statement changes the concept changes, and the new animation may not have any contextual relationship to the previous animation.

In contrast, the present invention was developed to provide an “on-the-fly” real time processing system wherein data stream elements (words, graphic elements, sound elements, or other discreetly identifiable information elements) are obtained, an element-by-element look up is performed, whereupon the element is processed and a result is immediately displayed. Rather than a static processing model, this is a real time processing procedure wherein a continuous scene evolves and changes in step.

### BRIEF SUMMARY OF THE INVENTION

Accordingly, a primary object of the present invention is to provide an information and communication that function in real time to detect discrete elements contained in a data stream, compare the element with a memory device on an element-by-element basis, and immediately display a result.

According to a more specific object of the invention, a word is received and buffered (stored in memory), the buffered word is looked up in an object data store device, and the result of the word is processed by comparing current running context information, the user's preference, and certain rule sets in accordance with the invention, thereby to produce display update component selection criteria. Based on the component selection criteria, the current output presentation is modified by extracting components from the appropriate data stores (in this case, graphics, audio, animation, and/or video clip libraries, and once the updated components have been selected, the program displays the selected data components. The program continues by looking to process the next input data element.

Another object of the invention is provide a system for handling multiple media types that contain discrete data elements.

For translating graphics data, a library of characteristic shapes is referenced and the input stream is processed to extract basic shape information and compare it to the shapes data store. Matches are processed based on the current running context information, the user's preferences, and given rule sets to generate the desired output. An example application would be to examine video of a person using sign language and to convert it to speech.

Another potential application is to take an audio stream, such as music, and convert it to a printed musical score. Again, the key underlying concept is to take any data stream with intelligible data elements, analyze the data elements on the fly, and produce a translated output based on the input.

Potential applications include virtual worlds, mapping and geographic information systems, terrain profile recognition, context aware applications, and media format translators. Major sales areas include the military, commercial, entertainment and medical fields.

The present invention provides a broad based application framework for processing intelligible data streams from one format into one or more alternate formats. This means that this processing approach has many different uses and across many different media types. In some cases, just changing data stores and rule sets can allow an application to completely change its form and function while the underlying program code remains the same. Since the concept, and often the program code, remains the same, the development of new applications based on the invention will be faster and able to take advantage of code reuse. Further, capitalizing on code reuse will result in more stable applications, lower development costs, and shorter time to market.

Example applications that could take advantage of present invention include:
(a) Text to multi-format text, graphics, and sound, such as enhanced computer chat room applications. By changing data stores and rule sets slightly, the personality of each chat room application could be varied to appeal to different audiences.
(b) Text or speech to animation, such as an interactive video game where the player is immersed into a virtual world. Once again, once the core engine is built, simple changes to data and rule sets to allow both variations to the same game, or whole new games to be produced. A comparable product concept is the simulation engines used in the gaming industry for first-person-shooting simulations.
(c) Speech to text and graphic output such as an imagineering tool to aid students and professional writers in the creative writing process. As a writer types a story, visual depictions of the word(s) are displayed to help guide and enhance the creative process.
(d) Object recognition, where graphic or video feeds are analyzed to provide rapid object identification for use in building improved sensors and radar systems (military, transportation, and emergency services). This could lead to imagery systems that can identify and warn or avoid obstacles such as high tension electrical towers for helicopter pilots who are flying in dense fog, smoke, or darkness.
(e) Object recognition applications for robotics where real time input must be acted on quickly, such as a transportation auto-navigation system.
(f) Rapid analysis and diagnosis tools such as an emergency responder who quickly describes a scene into a hand-held device and his description is programmatically translated into a set of most probable circumstances and best procedure recommendations. For example, a first responder arrives at an auto accident and indicates air bags have been deployed. The system application could use this reference to warn of a more serious impact and a high probability of internal injuries for the accident victims.

According to another object, the invention produces useful and meaningful concept sensing on the fly. If so programmed, the system can begin tracking the data stream and building context information. This allows the system engine to make better selections from the appropriate media libraries as the history of the data stream under analysis grows. This capability would take advantage of current processing methods such as decision trees, artificial intelligence, and/or fuzzy logic (as deemed appropriate for the particular system application).

According to a further object of the invention, user customization is achieved by combining context tracking based on the system requirements, the user can specify certain selectable behaviors and rules. Examples of this include: Selecting a content rating (similar to movies having G, PG, R, etc.), defining favorite object types (I like Siamese cats), setting graphics detail level to improve program response over slow communications media (broadband versus dial-up modem), or enabling local caching (saving content on the local hard drive or in local memory) to improve application responsiveness.

Applicant rules and settings are achieved for program behavior. While the underlying processing concept is the same, regardless of data stream type, to keep the size and complexity of the individual application manageable, each application would be tailored to the function it is designed to perform. For example, an interactive animated internet chat application might be tailored to handle only text input streams, with optional libraries for popular topics, and settings to facilitate logical options such as an option to block objectionable content for younger users.

The rule sets provide a means to guide the decision making of the inventive engine so that the translated output stream is both suitable and entertaining to the viewer. The settings within the rule base allow the user to fine tune application behavior, enhance performance, and control the amount of system resources used on the local computer.

A significant concern of computer users is the constant threat of computer viruses, Trojan horses, spy ware, mal-ware, and infected attachments. The inventive system combats these issues in several ways through its rule sets and options including:
(a) The very nature of data stream processing limits the risk of infection and attack because data elements that are not recognized (found in the dictionary as either a valid data element or an embedded command) are discarded.
(b) Where there is a possibility of loading, transferring, or processing at-risk data, the rule set model used by the inventive engine can include special program code to either check the data content directly, or to make a call to a commercial antivirus or firewall application to do so on the inventive engine's behalf.
(c) The programming standards employed by the inventive engine include practices to prevent buffer overrun and buffer under run conditions to prevent program hijacking.
(d) Rule sets that allow code module extensions will be engineered to restrict unauthorized access and to easily facilitate threat checking.
(e) Customization settings will permit users to set security levels to disable or restrict application features that could pose a risk of infection (similar to current internet browser applications).
(f) Installation, patching, enhancements and upgrade files will include MD5 signatures to allow the customer to verify the validity and integrity of the program files.

### BRIEF DESCRIPTION OF THE DRAWINGS

Other objects and advantages of the invention will become apparent from a study of the following specification when viewed in the light of the accompanying drawings, in which:

FIG. 1 is a block diagram flow chart illustrating the overall data processing flow.

FIG. 2 is a block diagram flow chart illustrating the processing steps of the process input string means of FIG. 1.

FIG. 3 is a block diagram flow chart illustrating the processing steps of the process display element means of FIG. 1.

FIG. 4 is a block diagram flow chart illustrating the processing steps of the request audio conversion means of FIG. 3.

FIG. 5 is a block diagram flow chart illustrating the processing steps of the request visual conversion means of FIG. 3.

FIG. 6 is a block diagram flow chart illustrating the processing steps of the display conversion means of FIG. 1.

FIG. 7 is a block diagram flow chart illustrating the processing steps of the display conversion means of FIG. 1.

FIG. 8 is a block diagram of the management interface system of the present invention.

FIG. 9 is a representation of the user console display.

FIG. 10 is an illustration of a stand-alone player application.

FIG. 11 is an illustration of the session editor tool.

FIG. 12 is a block diagram of the core system of the present invention.

FIG. 13 is a block diagram illustrating the method of analyzing the input text stream.

### DETAILED DESCRIPTION OF THE INVENTION

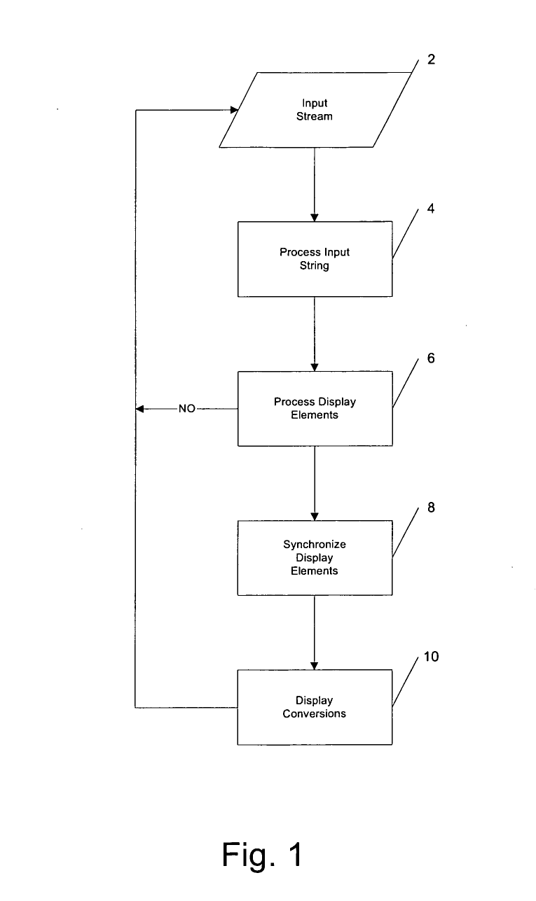

The processing system receives inputs in various formats such as text, audio, video, images, and other formats, and transforms the inputs into a multimedia output. In FIG. 1, which illustrates the high level processing steps of the overall system, an input data stream 2, which may be in a variety of formats, is received by the system. The input stream 2 is processed 4 whereby the input is analyzed, settings and rules are applied to the input, the input is stored in memory, and a determination is made as to whether the input data contains an embedded command or text requiring further processing. Based on system rules and user settings, the text stored in memory is analyzed and processed, thereby to produce the display conversion 6. If a successful determination is made to display the elements, a synchronization of all of the relevant display elements 8 occurs such that the simultaneous presentation of the visual, audio, textual, and other multimedia can occur. After the display elements have been synchronized, the display elements are sent to an output device whereby the conversion elements are displayed 10.

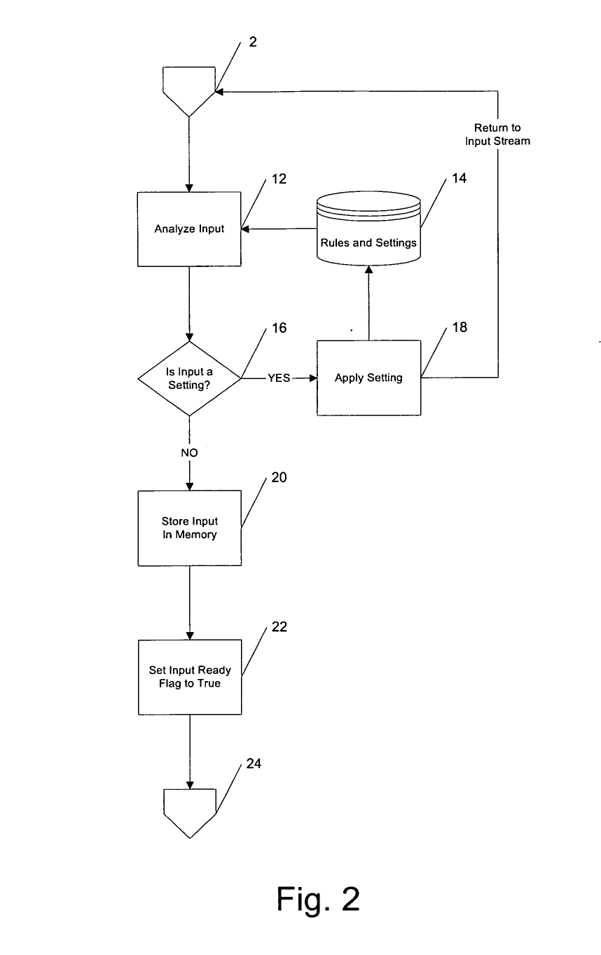

After the system receives the input data 2, the input is analyzed 12 in FIG. 2 whereby a combination of the user's settings and system rules determine which processing routines will be executed on the input 2. Settings and rules means 14 which may include fuzzy logic and/or artificial intelligence are utilized on the input 2 to enhance the user's experience of the system. A determination 16 is made as to whether the input 2 is either a user request for a change of a preference or setting or rule 14. If the input 2 is a change, the change is applied 18 to the setting and rules 14 and then processing returns to obtain and process further input 2. If the determination 16 is made that input 2 is not a setting or rule change request, the input 2 is stored in memory 20 for further processing. Further, an input ready flag is set to true 22, thereby to control subsequent processing actions.

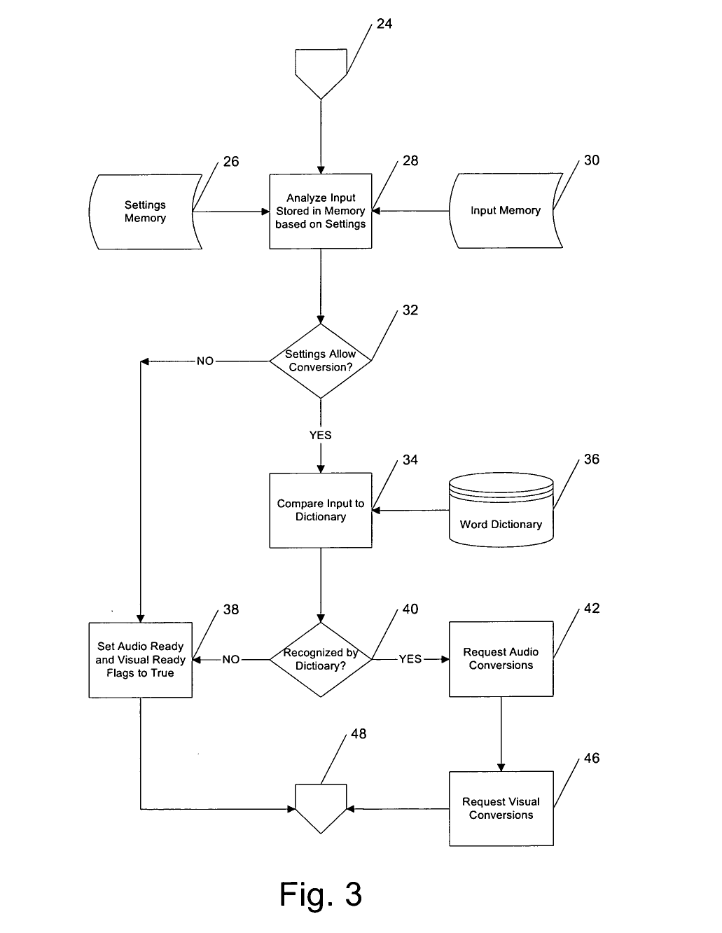

During the process display elements 6 processing of the overall system, the input is analyzed 28, in FIG. 3, by combining and applying the settings stored in memory 26 and the input stored in memory 30. A determination is made whether the settings allow for conversion 32 of the input. If the conversion is allowed, the input is compared to data source 36 (i.e., a word dictionary). A determination is made whether the input matches or is recognized by the data source 36. If the input is not recognized, the audio ready and visual ready flags are set to true 38 thereby to show that the clips have been denied so that the input processing may continue. The main purpose of setting the audio ready and visual ready flags is to assist with output synchronization. Additionally, if the determination is made that the settings do not allow for conversion 32, processing continues to set audio ready and visual ready flags to true 38, to also assist with output synchronization.

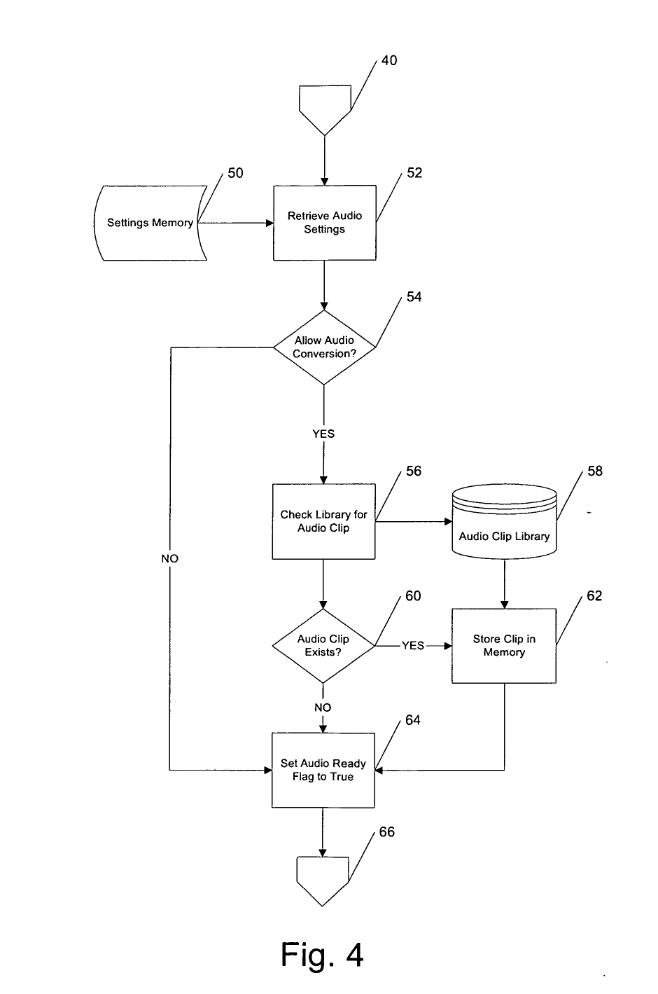

If the input is recognized by dictionary recognizing means 40 in FIG. 3, a request for audio conversion 42 is enacted. The processing details or request for audio conversion 42 are illustrated in FIG. 4. In processing the request audio conversions 42, the audio settings are stored in a settings memory 50 and retrieved from memory 52 to be utilized by the system. A determination is made whether the settings allow for audio conversion 54. If the settings do not allow for audio conversion, the audio ready flag is set to true 64 to enable output synchronization and further processing. If the setting does allow for audio conversion 54 a check 56 of the audio library 58 is conducted to identify audio clips associated with the input and to select the audio clip based on the combination of the applicable system and user settings and rules 14. A determination is made 60 to identify if an audio clip exists. If an audio clip does not exist, the set audio ready flag to true 64 occurs. If an audio clip does exist, the audio clip from the audio library 58 is stored in memory 62. After storing the audio clip in memory, the set audio ready flag to true 64 is set, thereby to enable output synchronization and further processing.

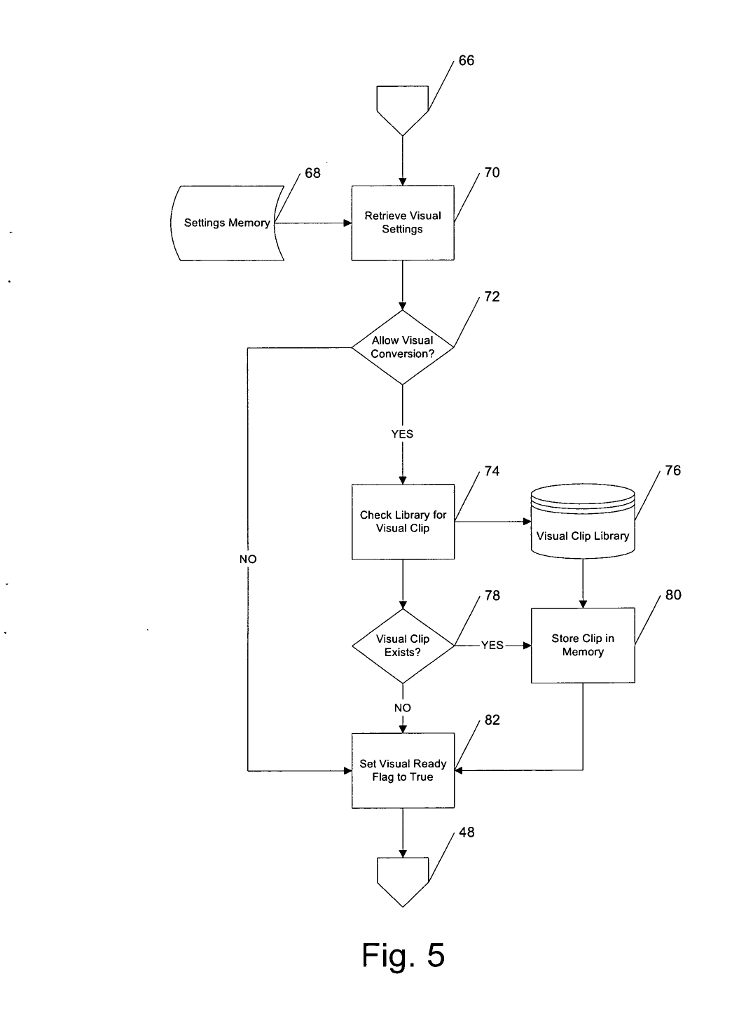

After the request audio conversions 42 occurs (FIG. 3), the request for visual conversions 46 occurs. The processing details of request for visual conversions 46 are illustrated in FIG. 5. In processing the request visual conversions 46, the visual settings are stored in a settings memory 68 and retrieved from memory 70 to be utilized by the system. A determination is made whether the settings allow for visual conversion 72. If the settings do not allow for visual conversion, the visual ready flag is set to true 82 to enable output synchronization and further processing. If the setting does allow for audio conversion 72 a check 74 of the visual library 76 is conducted to identify visual clips associated with the input and to select the visual clip based on the combination of the applicable system and user settings and rules 14. A determination is made 78 to identify if a visual clip exists. If a visual clip does not exist, the set visual ready flag to true 82 occurs. If a visual clip does exist, the visual clip from the visual library 76 is stored in memory 80. After storing the visual clip in memory 80, the set visual ready flag to true 82 is set, thereby to enable output synchronization and further processing.

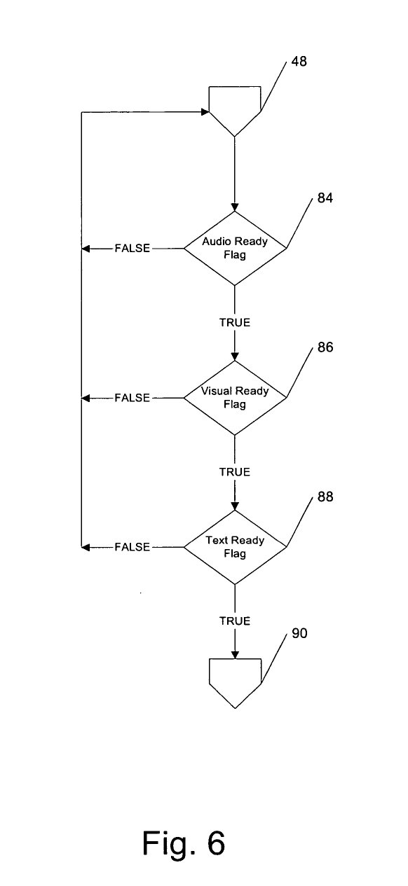

When the various components of the input have been processed by the system, it is then necessary to synchronize the audio, visual and textual components of the resultant multimedia output that the system has generated. The steps occur in the synchronize display elements 8 step of FIG. 1, and are further illustrated in FIG. 6. The audio ready flag 84 is first evaluated to determine if the audio clip processing is complete. If the audio ready flag 84 is not set to true, processing will return until the audio ready flag 84 is set to true. Once the audio ready flag 84 is set to true, processing continues to determine if the visual ready flag 86 is set to true. If the visual ready flag 86 is not set to true, processing will continue or loop until the visual ready flag 86 is set to true. Once the visual ready flag 86 is set to true, processing continues to determine if the text ready flag 88 is set to true. If the text ready flag 88 is not set to true, processing continues or loops until the text ready flag 88 is set to true. Once the text ready flag 88 is set to true, all of the output components are synchronized and ready to be sent to the output display.

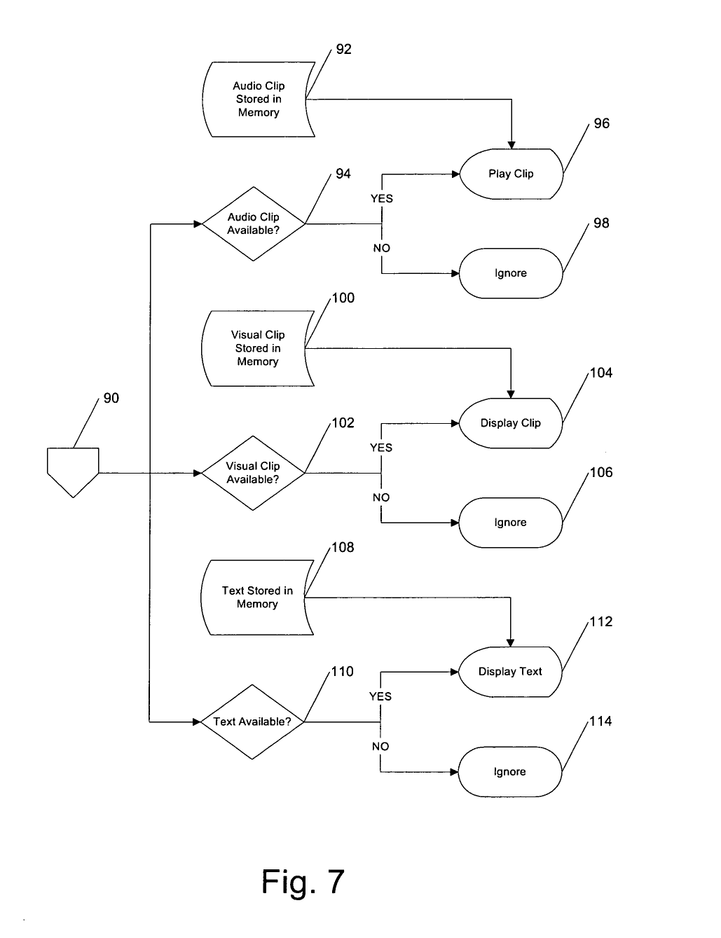

After the components that comprise the multimedia output have been synchronized, the system will display the conversions 10. The detailed processing steps for the display conversions 10, are illustrated in FIG. 7. The synchronized data enters the display conversions 10 process, and it is determined if there is an audio clip available 94. If there is an audio clip available, the audio clip is retrieved from the audio clip 92 stored in memory, and the audio clip is played 96. If there is no audio clip available 94, the request and processing of the audio clip is ignored 98. It is then determined if there is a visual clip available 102. If there is a visual clip available, the visual clip is retrieved from the visual clip 100 stored in memory, and the visual clip is displayed 104. If there is no visual clip available 102, the request and processing of the visual clip is ignored 106. It is then determined if there is text available 110. If there is text available, the text is retrieved from the text 108 stored in memory, and the text is displayed 112. If there is no text available 110, the request and processing of the text is ignored 114. At this point, the system has received input which may be in various forms, converted the input into a representative multimedia output, and generated the output to an audio, visual, textual, or combination output device.

The present invention my use a server having a single node or multiple nodes such as a grid computing cluster, that may reside on a local area network, a wide area network, or the Internet. In some cases, it could simply be an application running on the same computer as the client application.

The application uses a “rule set” database to determine application settings, context rules, animation actions, select appropriate multimedia components (animation clips, video clips, sound bytes, etc.), picture sequences, and composition rules.

The application uses a “content” database to store the building blocks for the output multipmedia stream. The “content” database may be stored on any tier of the architecture (client, web server, or database backend) depending on a combination of security, performance, and application requirements.

Objects may be locally cached to improve performance and help achieve ear real-time response. The objects may consist of many components including output object itself (animation clip, video clip, graphic, text file, sound byte, transitions, etc.) or metadata (information about the object) that may include object viewer rating, author information, media type (animation, video, audio, text, graphic, etc.), media format (.mov, .mpeg, .wav, .txt, .swf, etc.), general description, default editing software, genre, color information, sizing information, texture information, or information relevant to creating data marts for special application requirements.

Database indexes for use in creating, accessing, and maintaining objects stored in the database.

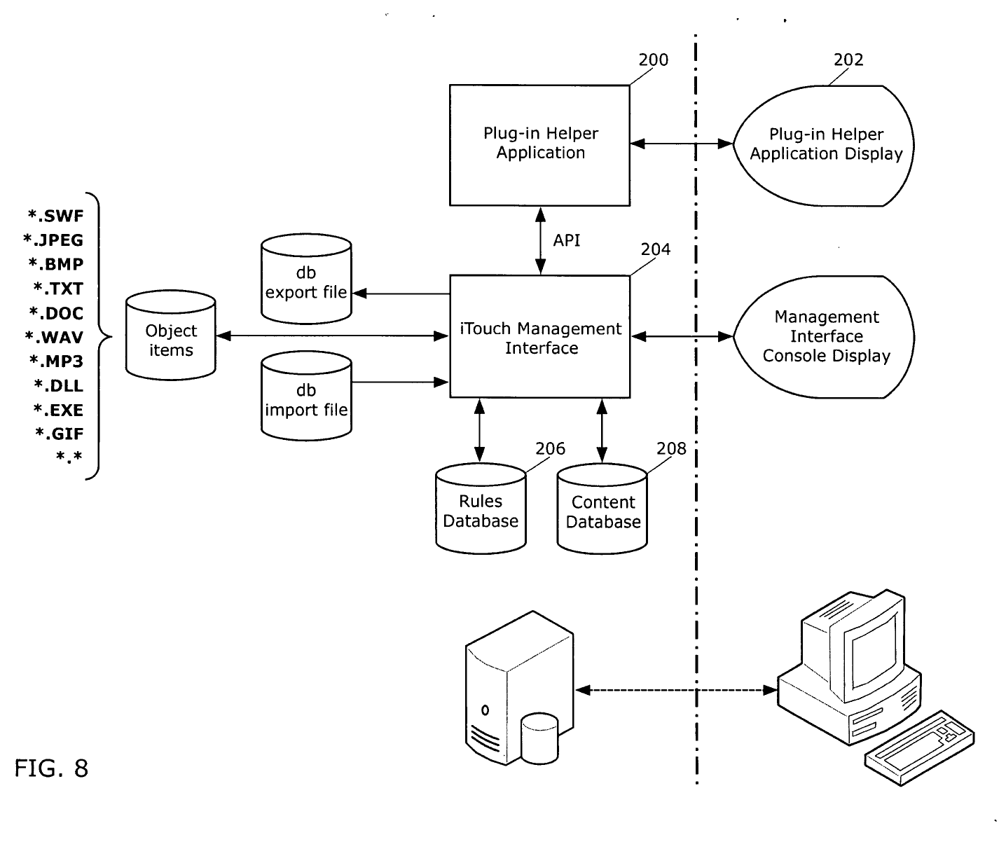

Referring now to FIG. 8, the applications of the present invention utilize a separate management interface on the backend to aid in building, maintaining, and administrating the “rule set” and “content” backend databases. This tool is a systems tool that is not intended for customer use, but is used for application development and maintenance. It allows typical maintenance functions for database objects including create, add, modify, delete operations, facilitates full and partial database import and export operations, and facilitates database maintenance and repair activities.

The Plug-in-Helper Application box 200 represents additional programs written to meet special application requirements such as database administration, index maintenance, data cleansing, data load/unload programs, reporting programs.

The Plug-in-Helper Application Display 202 is a windowed display to facilitate interaction with the helper application. Not shown with the display are input devices such as a keyboard and a pointing device.

The management interface application 204 provides a tool for loading and unloading database objects. These objects may include simple graphics files, animation files, text files, executable scripts/programs, music files, sound bytes, etc. The management interface application is one of the tools that allows meta data to be entered and/or edited for database objects.

The management interface application provides an easy option to create a database export file containing a collection of database objects and meta data.

The Management Interface application provides an easy to use tool for routine administration of the rules and content databases 206 and 208. The tool is easily enhanced through the use of plus-in-helper applications.

The Management Interface 204 is a windowed display to facilitate user interaction with the management interface application. Now shown are input devices such as a keyboard and a pointing device.

The management interface application provides an easy to use option to load database records from an import file into either the rules database or the content database. It provides full administrative and reporting access to the Rules Database. The management interface application also provides full administrative and reporting access to the Content Database. Typically, the Rules and the Content databases reside on a dedicated database server. The management interface application runs as a server process on the database server platform. Access to the management interface application is normally done as a client from an administrative workstation through a standard web browser applications such as Microsoft's Internet Explorer.

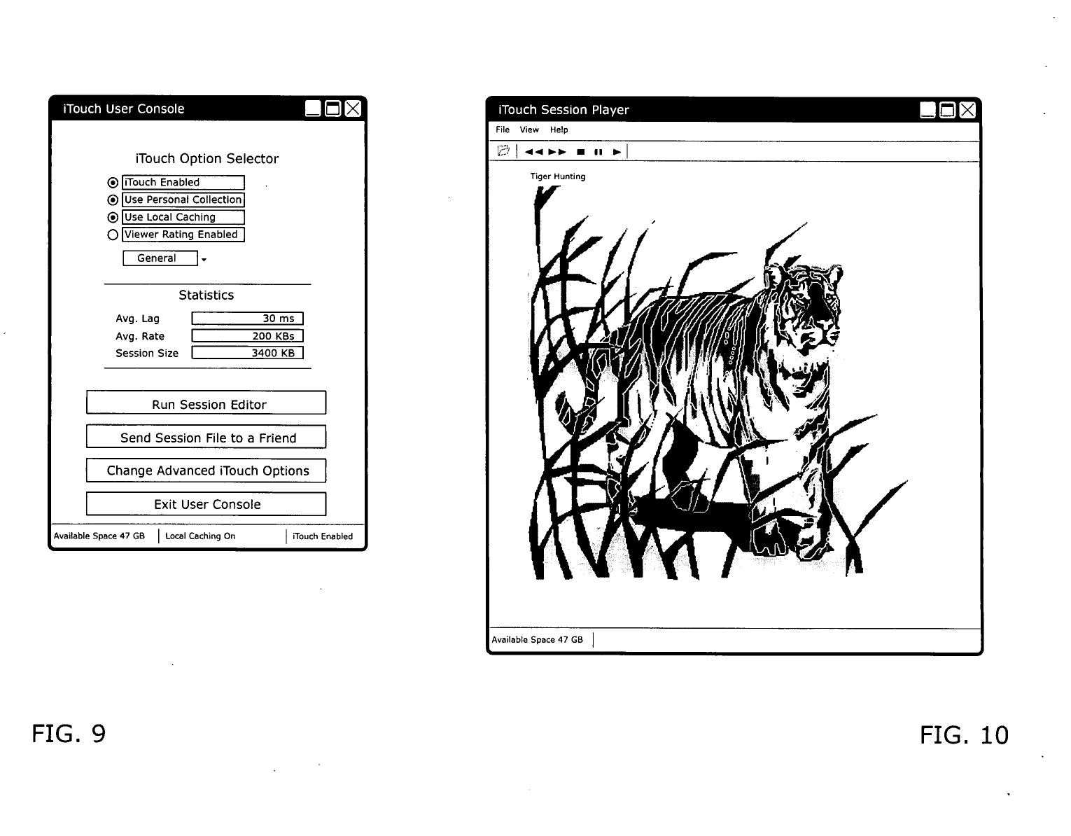

The application suite includes a User Console (FIG. 9) to allow the end-user to set preferences, record sessions, play back pre-recorded sessions, and start the end-user Session Editor.

The User Console provides an easy to use interface to enable, set up, and monitor the application. Highlights to this interface include a standard window that provides a familiar interface and may be managed like any other windowing application. Note the help button so that the end user can quickly access help documentation.

The most commonly used/changed settings appear at the top of the first panel. In this example, you see the options to activate the application, select personal object collections, use local caching (for improved application performance), and for changing the user viewer rating to control the content that may be viewed.

Key performance statistics help the end user to see the effect of changing various performance options and provide an aid in determining overall system performance in the event there are bandwidth problems, for example.

The bottom of the first window contains buttons for accessing more advanced options, optional application, or for exiting the User Console.

A status bar can be activated to show current status information and settings.

The User Console will vary in content and function depending of the specific application.

The Player application is a stand-alone application that allows a subscriber's friends or relatives to view recorded playback files. This program is similar in concept to the free distribution of the Adobe Acrobat file reader application.

Details shown in FIG. 10 for the example Player window include a simple file folder icon is provided to allow easy location of playback files. Standard pull down menus make operation of the Player straight forward and easy. An iconic playback control button array provides one touch controls for playing sessions, pausing, stopping, or skipping frames. A help window is only a mouse click away. A status bar shows application related statistics and information.

Parental controls can provide limits as to the viewer ratings or content collections which may be displayed.

The Player can only play special playback format files created by the Session Editor. The playback file format cannot be edited or easily decomposed so that proprietary content and subscriber personal content are protected.

The Player can include advertising elements to help defer free distribution costs.

Trial subscriptions to products will be included in the player application's menus and splash screen.

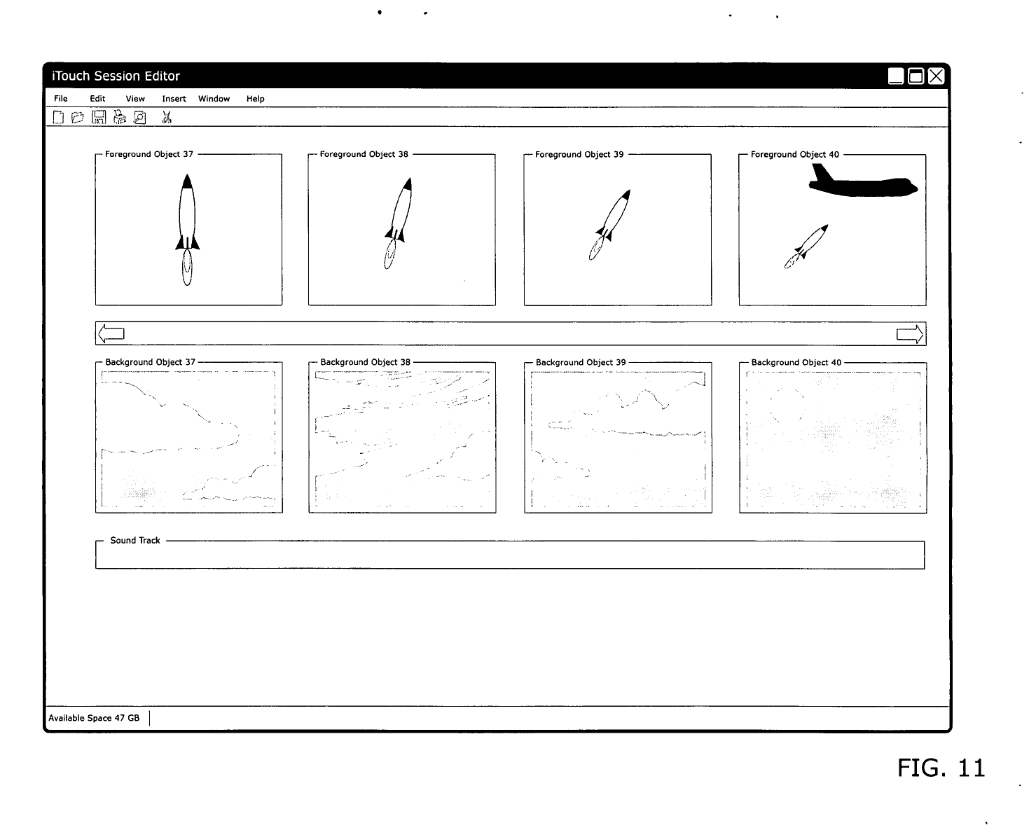

Referring now to FIG. 11, the Session Editor provides the end-user with a simple composition and editing tool to manipulate their recorded session files. Session Editor features and capabilities include the ability to add or remove session objects (pictures, clips, sounds, etc.), the re-sequencing session objects, modifying some characteristics of objects (where allowed) such as color, background, sound bytes, background music, etc., adding titles and subtitles, and replacing generic objects with objects from their personal database collections. Standard windowing environment includes standard pull down menus, function icons for commonly used actions and features, a windows help facility that is only a mouse click away, a multi-frame view of foreground objects, an intuitive frame control button bar, a multi-frame view of background objects, a sound track frame editor, and a status bar for displaying key application and system information.

An important feature of the application family is the ability to have “personalized” objects that they can use to personalize their “content” collections. Some points about personalized content collections include that the personalized content could physically reside on any tier (client, web server, or backend).

This feature allows the end-user to actually reference their car, boat, house, street, family, etc., so that they can have a more personalized experience using the application.

Depending on the application, end-users might be able to purchase related “collections” of objects to enhance their experience. For example, they might purchase a baseball collection that provides additional objects related to their favorite pastime.

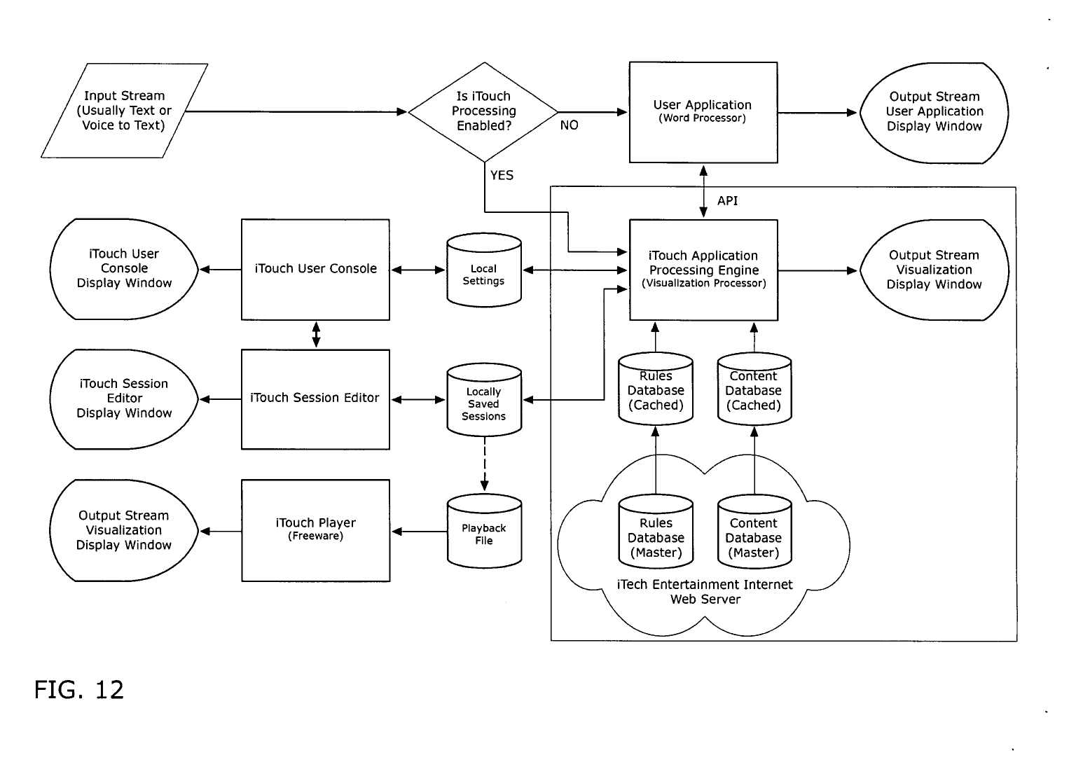

The client applications environment is shown in FIG. 12. Major components include the core application, the host application, the session editor, the player application and the host database server.

The User Application Output Stream is not managed or controlled by the application unless the control is through the User Application's Application Programming Interface (API). While the simplified drawing does not show it, each diagram display icon also assumes associated input devices such as a keyboard and pointing device.

The User Console Display Window is a standard windowing environment applications window. It may be resized, minimized, maximized, and moved per the user's desire. While the simplified drawing doesn't show it, each diagram display icon also assumes associated input devices such as a keyboard and pointing device.

The User Console application is spawned by the Application Processing Engine and provides the end user with a control panel for setting Application parameters, managing local personalized object libraries, activating the Session Editor, controlling the recording of session files, and viewing Application runtime statistics.

The Application maintains local files to retain application settings, personalized object libraries, user preferences, etc.

The Application Processing Engine is the client-side application for Applications. It provides the program logic, processing, and file management for all client-side application engine processing requirements. Its features and sophistication will vary depending on the specific application implementation and the options purchased.

The Output Stream Display Window is a standard windowing environment applications window. It may be resized, minimized, maximized, and moved per the user's desire. While the simplified drawing doesn't show it, each diagram display icon also assumes associated input devices such as a keyboard and pointing device.

The Session Editor Display Window is a standard windowing environment applications window. It may be resized, minimized, maximized, and moved per the user's desire. While the simplified drawing doesn't show it, each diagram display icon also assumes associated input devices such as a keyboard and pointing device.

The Session Editor is an optional application that allows saved session files to be managed and modified.

The Local Saved Sessions are simply files that are recorded by the Application Processing Engine for use by the Session Editor.

The cached Rules Database is a selectable option that enhances application processing speed, especially when the network connection is a low band width connection or is experiencing slow performance. Typically, the most recently used and most frequently used “rules” are cached.

The cached Content Database is a selectable option that enhances application processing speed, especially when the network connection is a low bandwidth connection or is experiencing slow performance. Typically, the most recently used and most frequently used “content” objects and meta data are cached.

The Output Stream Player Display Window is a standard windowing environment applications window. It may be resized, minimized, maximized, and moved per the user's desire. While the simplified drawing does not show it, each diagram display icon also assumes associated input devices such as a keyboard and pointing device.

The Player is an optional Freeware application that allows saved Playback files to be viewed. A more detailed description of the Player is presented earlier in this paper.

The Playback File is a special file format for viewing only. The file may be viewed using either the Player or the Session Editor.

The primary source for “rules” information for network or web based application is the Rules Master Database that is served from an Internet Web Server.

The primary source for “content” information for network or web based application is the Content Master Database that is served from an Internet Web Server.

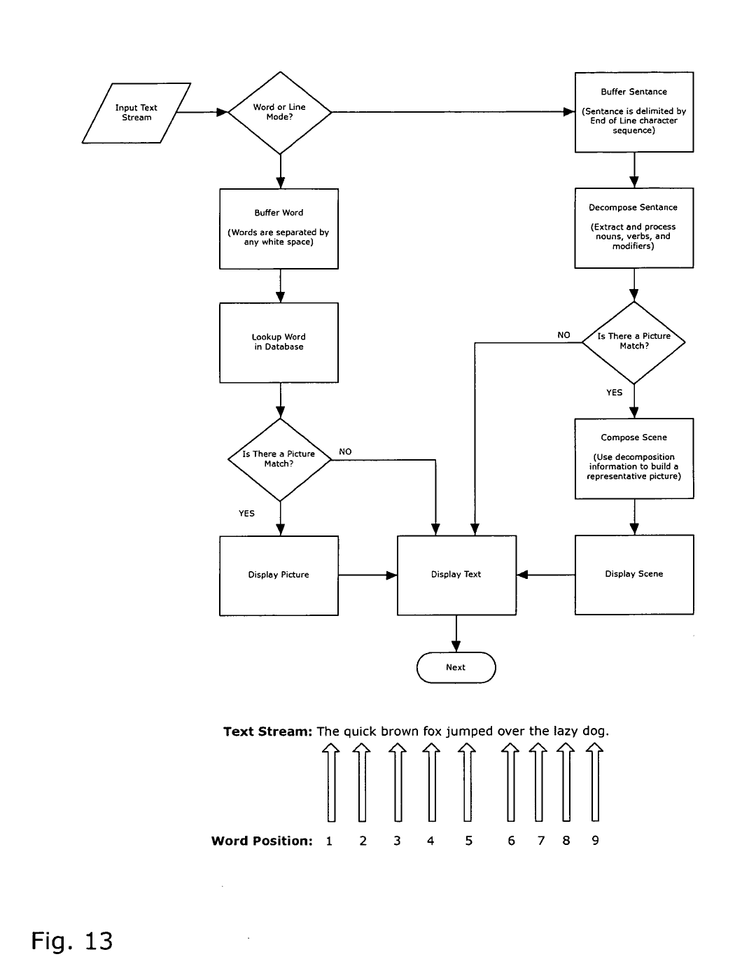

The core components of the invention break down into the Application Processing Engine (FIG. 12) which represents the software program that contains all of the programming logic, interface drivers, and error handlers necessary to effect a particular application. FIG. 13 provides a high-level logic flow diagram to illustrate the core functionality. It is important to note that the code and structure for a particular application will vary significantly depending of the requirements for that application. Also, as shown in FIG. 12, the Application Processing Engine may communicate with other applications (potentially using Application Programming Interfaces, programming pipes, or via data files) to offload optional and/or utility functions such as session editors or file viewers.

The rules database (FIG. 12) contains all of the behaviors and actions to be performed based on the user settings, the words received, and the theme of the application. As shown in FIG. 12, the application is web server based and uses local caching for improved application responsiveness. Some applications may only need a simple local data file for the rule database and other applications may require very sophisticated database systems. The main point here is that a database is used to contain the major behaviors for the application.

The content database (FIG. 12) either points to or contains all of the objects used to compose scenes displayed by the application. As shown in FIG. 12, the application is web server based and uses local caching for improved application responsiveness. Some applications may only require a local lookup table to reference local user objects, while other applications may require very sophisticated remote database systems to supply very large libraries of scene components. The main point here is that a database is used to either reference or provide objects for the application to construct a multimedia display.

The Application Output Stream (FIG. 12) is the multimedia output device, or devices, used to present the composed scene generated by the Application Processing Engine.

A diagram depicting high level program logic flow for the application of the present invention is shown in FIG. 13. In this application, the option exists to perform processing either against each word as it is received, or processing each sentence to achieve greater context for building a higher quality multimedia presentation.

The option to process the input stream at a word level may be designed when processing bandwidth is limited and a more responsive display is desired, when in a chat scenario, a snappier output is desire, and when a more cartoon-like rendition is desired.

The option to process the input stream at the sentence level allows greater context and language analysis to be performed. The resulting output stream can be composed in greater detail and greater contextual accuracy resulting in a more finished multimedia output stream. The cost is higher processing, memory, and bandwidth requirements.

FIG. 13 illustrates that the Input Text Stream provides a flow of information to be processed by the application. In this example, the option to process word-by-word or at the sentence level determines which logic path the input stream will take. In the word-by-word path, a sub-process receives characters while checking for work separator characters (usually white space characters including spaces, tabs, or end-of-line characters). As a word is processed, it is returned for further processing, each word is looked up in the database. If there are additional rules in effect, such as a user preference for animated pictures, then a check is done to see if a better match exits. Once all of the rules currently in force are checked, the ID of the object with the “best” match is sent to the Display Picture sub-process. If there is no object that matches the word, the last picture displayed remains and processing continues.

The Display Picture sub-process uses the object ID to retrieve the object from the content database and present it to the output stream(s).

In this example, the text from the Input Text Stream is sent to the Text Display output stream.

If processing by Line is selected, then a sub-process receives characters while checking for work separator characters (usually white space characters including spaces, tabs, or end-of-line characters). As a word is processed, it is stored. Each word is accumulated and processed until a sentence punctuation mark or an end-of-line (EOL) character sequence is recognized.

The “line” is then passed to a sub-process for contextual and grammatical analysis. Also, any additional rules or special processing options in effect are used to fully analyze and process the text line. A set of “recommended” components for background objects(s), scene colors, foreground objects, sound, and presentation are crated based on the current “rules” and “line” processing are packaged in a scene.

This scene is evaluated to see if it can produce an output. If not, the last scene produced remains in effect and processing continues.

If the scene can be processed, the a sub-process pulls the required scene component IDS for all of the components in the object database. Retrieves the components from the database. Assembles the scene, then presents the scene to the output stream. Again, in this example, the text from the Input Text Stream is sent to the Text Display output stream.

This process continues as long as the application is active.

While in accordance with the provisions of the Patent Statutes the preferred forms and embodiments of the invention have been illustrated and described, it will be apparent to those skilled in the art that various changes may be made without deviating from the inventive concepts set forth above.

What is claimed is:

1. A method for translating an input data stream including discrete data elements of one media type into an output data stream having a multimedia representation of the elements of said input stream comprising:
(a) identifying the data elements of the input data stream;
(b) translating in real time the data elements to at least one different media type, and simultaneously analyzing and applying untextual rules, user-defined rules, and application-defined rules;
(c) retaining historical data stream information to built a context related to the characteristics of the data stream; and
(d) selecting the output data elements from the media data storage means and delivering the stream translation to the output data stream.

2. The translating method defined in claim 1, wherein said translating step includes converting data from the input data source into at least one output data stream into a data sink.
